(19) United States
(12) Patent Application Publication
(10) Pub. No.: US 2024/0066525 A1
(43) Pub. Date: Feb. 29, 2024

(54) RECOVERING VALUABLE MATERIAL

(71) Applicant: Newcrest Mining Limited, Melbourne (AU)

(72) Inventors: David Seaman, Melbourne (AU); William Futcher, Melbourne (AU); Malcolm Strathmore Powell, Melbourne (AU)

(21) Appl. No.: 18/280,121

(22) PCT Filed: Mar. 7, 2022
(86) PCT No.: PCT/AU2022/050187

§ 371 Date: Sep. 1, 2023

(30) Foreign Application Priority Data
Mar. 5, 2021 (AU) 2021900628

(51) Int. Cl. B02C 23/08; B03D 1/08

(52) U.S. Cl. CPC B02C 23/08; B03D 1/085; B03D 2203/025

(57) ABSTRACT

A process and a plant for recovering valuable material in the form of gold and/or copper from sulphide ore systems that includes an Accurate Rock Breakage System (“ARBS”) circuit.

### TECHNICAL FIELD

The invention relates to recovering valuable material.

The invention relates particularly, although by no means exclusively, to recovering valuable material in the form of gold and/or copper from sulphide ore systems.

In particular, although by no means exclusively, the invention provides a process and a plant for recovering valuable material in the form of gold and/or copper from sulphide ore systems.

The invention is not confined to recovering gold and copper from sulphide ore systems and extends to recovering valuable metals generally from ore systems.

### BACKGROUND ART

The applicant is a gold mining company.

The applicant has carried out research and development work into conventional process flowsheets for recovering gold and copper from a sulphide ore system, including low-grade porphyry style copper-gold deposits.

The applicant has mining operations in Australia, Canada and PNG.

A Canadian operation is the Red Chris mine.

The Red Chris mine operates with an example of a conventional process flowsheet for recovering gold and copper from a sulphide ore system.

The Red Chris mine is currently a drill and blast, shovel and truck open pit mine that produces run of mine (ROM) ore.

The Red Chris process flowsheet for recovering gold and copper from ROM ore includes:
(a) a comminution (primary crush and SAG and ball mill) circuit for ROM ore that produces fines; and
(b) a fines flotation circuit that produces (i) a concentrate stream that contains gold and copper and (ii) a tailings stream.

Copper concentrate is dewatered and hauled off-site for transport overseas.

Process plant tailings are separated into potential acid generating (PAG) and non-acid generating (NAG) components during processing and transported to separate areas in the tailings impoundment area.

The Red Chris process flowsheet is typical of many conventional process flowsheets for recovering gold and copper from ROM ore that comminute ROM ore to fines and process the fines, including by flotation, to recover gold and copper.

Another example is the process flowsheet for Boddington Operations that is described on page 134 of Technical Report NI 43-101 by Donald Doe dated 31 Dec. 2018 cited in an International-Type Search Report prepared by the Australian Patent Office for Australian Provisional Patent Application No. 2021900628.

The invention is concerned with providing an alternative process flowsheet to conventional process flowsheets for recovering gold and copper from a sulphide ore system, such the process flowsheets described above in relation to the Red Chris and Boddington mines.

The above description and the following description of a so-called Accurate Rock Breakage System (“ARBS”) circuit are not an admission of the common general knowledge in Australia or elsewhere.

### SUMMARY OF THE DISCLOSURE

The disclosure herein integrates the Accurate Rock Breakage System (“ARBS”) circuit into process flowsheets for recovering gold and copper from gold/copper-containing sulphide ore systems.

The disclosure herein is not confined to recovering gold and copper and extends to recovering other valuable metals from ore systems.

The disclosure heroin is also not confined to sulphide ore systems and also extends to other ore systems such as oxide ore systems.

The ARBS circuit is an alternative to conventional comminution circuits, such as a SAG/ball mill circuit, used in the mining industry and has potential advantages over conventional comminution circuits.

The text book entitled “Mineral Comminution Circuits—Their Operation and Optimisation” published by the Julius Kruttschnitt Mineral Research Centre in 1996 (“the JKMRC text”) describes that the term “comminution” includes, by way of example, the use of the following equipment for causing size reduction of feed material:
crushers, including jaw crushers, gyratory crushers, cone crushers, roll crushers, high pressure grinding rolls, and impact crushers;
stirred grinding mills, including tower mills, vertical pin mills, and horizontal pin mills;
tumbling grinding mills, including autogenous (AG) mills, semi-autogenous (SAG) mills, rod mills and ball mills.

The text book entitled “Wills' Mineral Processing Technology” Seventh Edition by Barry Wills, revised by staff of the Julius Kruttschnitt Mineral Research Centre (reprinted 2007)(the “Wills text”), at page 108, describes that: “Comminution in the mineral processing plant . . . takes place as a sequence of crushing and grinding processes . . . . Crushing is accomplished by compression of the ore against rigid surfaces, or by impact against surfaces in a rigidly constrained motion path. This is contrasted with grinding which is accomplished by abrasion and impact of the ore by the free motion of unconnected media such as rods, balls or pebbles.”

Later passages in the Wills text describe the comminution stages of crushing and grinding as follows:
“Crushing is the first mechanical stage in the process of comminution in which the main objective is the liberation of the valuable minerals from the gangue.”
“Grinding is the last stage in the process of comminution; in this stage the particles are reduced in size by a combination of impact and abrasion, either dry or in a suspension of water.”

The JKMRC text and the Wills text describe a number of comminution circuits that are combinations of crushing and grinding stages.

By way of example, pages 174 and 175 of the Wills text describes a comminution circuit operating at the Cadia mine of the applicant that comprises a primary crusher, a SAG mill, two pebble crushers, and two parallel ball mills in a closed circuit with cyclones.

It is noted that, whilst particle separation units, including screens, sieve bends, hydrocyclones, and other classifiers, do not of themselves reduce the size of feed material, they are often part of comminution circuits.

The following description of the invention includes references to comminution circuits, including comminution involving combinations of crushing and grinding stages and particle separation units. The above extracts from the JKMRC text and the Wills text are understood herein to describe what is meant by these terms.

It is noted that the JKMRC text and the Wills text do not describe the ARBS circuit.

The ARBS circuit is a new technology (2019) that is based on a vertical stack of multiple stages of horizontally-opposed pairs of rolls with each roll pair being configured to operate with single particle breakage of rock fragments passing through the roll pair so that a relatively small proportion of fragments are crushed in each roll pair. Single particle breakage in each roll pair provides an opportunity to minimize energy requirements to operate the circuit. The ARBS circuit also provides an opportunity to produce a far steeper final particle size distribution curve than a conventional comminution circuit, such as a SAG/ball mill circuit, and this can provide advantages in downstream process options.

The ARBS circuit (process and apparatus) is described in International application PCT/IB2020/050065 (WO 2020/141496) in the name of Malcolm Strathmore Powell, with a priority date of 5 Jan. 2019, and the disclosure in the International application is incorporated herein by cross-reference.

As noted above in relation to the Red Chris mine, a conventional process flowsheet includes (a) a comminution circuit, for example including crushing and milling operations, that produces a fines stream from ROM ore or primary-crushed ROM ore and (b) a fines flotation circuit that processes the fines stream and produces (i) a fines concentrate stream that contains gold and copper and (ii) multiple tailings streams.

The applicant has realized that the ARBS circuit provides opportunities for alternative process flowsheets to conventional flowsheets that include conventional comminution circuits.

In addition to the above, the disclosure herein includes an optional use in process flowsheets of a coarse particle flotation circuit that produces a valuable coarse flotation stream and a coarse tailings stream.

One example of a coarse particle flotation circuit that can capture particles up to and exceeding 2 mm is described in U.S. Pat. No. 6,425,485 in the name of Eriez Manufacturing Co., with a priority date of 26 Mar. 1998, and the disclosure in the US patent is incorporated herein by cross-reference.

The Eriez coarse particle flotation circuit is marketed by Eriez under the trade mark Hydrofloat™.

It is noted that the disclosure herein is not confined to an Eriez coarse particle flotation circuit and extends to the use of any suitable coarse particle flotation circuit.

The disclosure herein includes multiple inventions of process flowsheets and plants for recovering gold and copper that include an ARBS circuit.

The description of the inventions includes references to several terms, defined as follows:

The term “coarse particle flotation” is understood herein to mean flotation that separates valuable coarse particles from waste coarse particles.

The term “coarse” in the context of coarse particle flotation is understood herein to mean valuable particles and waste particles (i.e. gangue) at an optimum size fraction for coarse particle flotation having particle sizes of at least 150 microns, typically in a range of 150-1000 microns, more typically in a range of 150-1000 microns, and more typically 150-600 microns, in the context of recovering gold and copper from sulphide ore systems.

The term “fines flotation” is understood herein to mean flotation that separates valuable fines particles from waste fines particles.

The term “fines” in the context of fines flotation is understood herein to mean valuable particles and waste particles at an optimum size range for fines flotation, typically in a range up to 200 microns, in the context of recovering gold and copper from sulphide ore systems.

The terms “coarse” and “fines”, together with the term “mid-size”, are also used herein in the context of size fractions produced is size separation steps on ROM or at least primary crushed ore.

For example, the term “mid-size” is understood herein to mean valuable particles and waste particles at an optimum size range for processing in an ARBS circuit. The size range for mid-size particles is between, although may overlap to an extent, the particle size ranges of coarse and fines.

It is noted that the particle size distributions for “coarse”, “mid-size”, and “fines” will vary depending on particular gold and copper mining operations.

Invention 1

In broad terms, invention 1:
(a) separates ore obtained from a sulphide ore system which may be run-of-mine (ROM) or at least primary crushed ore), for example by screening, into a fines fraction, a mid-size fraction, and a coarse fraction;
(b) comminutes the mid-size and optionally the coarse fractions in an Accurate Rock Breakage System (“ARBS”) circuit and produces (i) an ARBS milled stream and (ii) an ARBS process fines stream;
(c) recovers, for example via a flotation circuit, gold and/or copper from the ARBS milled stream.

In one embodiment, invention 1:
separates, for example by screening, ore (which, for example may be ROM including stockpiled ore or at least primary crushed ore) into (a) a mid-size fraction, (b) a fines fraction, and (c) a coarse fraction,
transfers the mid-size fraction and optionally the coarse fraction to and processes the fraction(s) in an ARBS circuit and produces (i) an ARBS milled stream and (ii) an ARBS process fines stream, and
transfers the fines fraction and optionally the coarse fraction to and processes the fraction(s) in a comminution circuit, such as a conventional comminution circuit, such as a crushing and milling circuit, such as a SAG/ball mill circuit, such as a SABC (SAG Ball Crush) circuit, and produces a fines stream; and
recovers, for example via a flotation circuit, gold and/or copper from the ARBS milled stream and the fines stream.

The applicant has found that there is a synergistic effect with the above-described split of the mid-size, coarse and fines fractions and downstream processing of at least the mid-size fraction and optionally the fines fraction.

The synergistic effect is due to a number of factors.

One factor is that the mid-size fraction is optimum for the ARBS circuit and the fines fraction is optimum for the comminution circuit.

Another factor is that the breakage rates for the mid-size fraction are low in currently-available SAG mills, and therefore there is an improvement in energy efficiency in the conventional circuit by removing this material from the feed to the comminution circuit.

In broad terms, invention 1 provides a process for recovering valuable material in the form of gold and/or copper from a sulphide ore system that includes:
(a) separating an ore obtained from a sulphide ore system (which may be ROM or at least primary crushed ore), for example by screening, into a fines fraction, a mid-size fraction, and a coarse fraction;
(b) comminuting the mid-size and optionally the coarse fractions in an Accurate Rock Breakage System (“ARBS”) circuit and producing (i) an ARBS milled stream and (ii) an ARBS process fines stream;
(c) recovering, for example via a flotation circuit, gold and/or copper from the ARBS milled stream.

The ore may be run-of-mine (ROM) ore, including stockpiled ROM ore.

The ore may be primary crushed ore.

The process may include comminuting the fines and optionally the coarse fractions in a comminution circuit, such as a conventional comminution circuit, such as a crushing and milling circuit, that produces a fines stream.

Step (c) may include recovering, for example via a flotation circuit, gold and/or copper from the fines stream and the ARBS milled stream.

The process may include processing ore between a mine (or a stockpile of mined ore) and step (a). For example, the ore may be processed by being sorted by grade (i.e. concentration, of valuable or non-valuable elements/compounds in the ore) between the mine (or the stockpile of mined ore) and step (a). For example, the grade sorting may be bulk and/or particle sorting.

The process may include processing the fines fraction and/or the mid-size fraction and/or the coarse fraction between separation and downstream comminution steps and between comminution and downstream recovery steps. For example, the process may include sorting the mid-size fraction by grade (i.e. concentration, of valuable or non-valuable elements/compounds) before step (b). For example, the grade sorting may be bulk and/or particle sorting.

The fines and the coarse fractions may be comminuted in the same comminution circuit.

The fines and the coarse fractions may be comminuted in different comminution circuits.

Step (b) may include comminuting the mid-size fraction only in the ARBS circuit.

Step (b) may include comminuting the mid-size and the coarse fractions in the ARBS circuit.

The process may include recovering, for example via a flotation circuit, gold and/or copper, from the ARBS process fines stream produced in step (b).

The process may include processing the ARBS milled stream produced in step (b in a coarse particle flotation circuit, such as an Eriez coarse particle flotation circuit, and producing a valuable coarse flotation stream.

There may be multiple coarse particle flotation stages in the coarse particle flotation circuit.

The applicant believes that there may be a benefit in some situations having multiple stage coarse flotation to reject greater quantities of waste material prior to downstream processing steps.

The coarse particle flotation circuit may include a plurality of coarse particle flotation stages in series or parallel.

The process may include recovering, for example via a flotation circuit, gold and/or copper, from the valuable coarse flotation stream.

The process may include comminuting the valuable coarse flotation stream and producing a fines stream.

The process may include recovering, for example via a flotation circuit, gold and/or copper, from the fines stream.

The process may include processing the ARBS milled stream produced in step (b) in a conventional comminution circuit, for example in a ball mill or vertical stirred mill, of the ARBS milled stream producing a fines stream.

The process may include recovering, for example via a flotation circuit, gold and/or copper, from the fines stream.

The mid-size fraction produced in step (a) may be any suitable size range.

The skilled person understands that the mid-size fraction as described herein is a size range that is between coarse and fines fractions. In any given situation, the size range of the mid-size fraction will depend on a range of factors, including the characteristics of the selected ARBS circuit and the mineralogy of the ore.

By way of example, in a gold/copper mining operation, the mid-size fraction may be 10-100 mm.

It is noted that references to particle size ranges herein are understood to mean that at least 90 wt. %, typically at least 95 wt. %, of the particles are within the upper and lower limits of the size range.

Typically, the mid-size fraction produced in step (a) is 10-80 mm, typically equal to or greater than 10 mm, and typically less than or equal to 80 mm.

The fines fraction produced in step (a) may be less than 10 mm.

The coarse fraction produced in step (a) may be greater than 60 mm.

Typically, the coarse fraction is greater than 80 mm.

The particles in the coarser stream may be less than 100 mm, typically less than 90 mm.

The ARBS milled stream may be 50-1000 microns.

The ARBS milled stream may be at least 50 microns, typically at least 75 microns.

The ARBS milled stream may be less than 1000 microns, typically less than 600 microns, more typically less than 500 microns.

Typically, the ARBS milled stream distribution may have a P80 (80% of the stream mass lower than) a range from 150-600 microns, typically 150-400 microns.

The invention also provides a plant for recovering valuable material in the form of gold and/or copper from a sulphide ore system that includes:
(a) a separation unit for separating an ore obtained from a sulphide ore system (which may be run-of-mine (ROM) including stockpiled ore or at least primary crushed ore) into a fines fraction, a mid-size fraction, and a coarse fraction;
(b) an Accurate Rock Breakage System (“ARBS”) unit for comminuting the mid-size optionally the coarse fractions and producing (i) an ARBS milled stream and (ii) an ARBS process fines stream; and
(c) a recovery unit for recovering, for example via flotation, gold and/or copper from the ARBS milled stream.

The plant may include a comminution unit for comminuting the fines and optionally the coarse fractions in a comminution circuit, such as a conventional comminution circuit, such as a crushing and milling circuit, and producing a fines stream.

The plant may include a recovery unit for recovering, for example via flotation, gold and/or copper from the fines stream.

The plant may include a recovery unit for recovering, for example via flotation, gold and/or copper from the ARBS process fines stream.

The plant may include a coarse particle flotation circuit, such as an Eriez coarse particle flotation circuit, for the ARBS milled stream for producing a valuable coarse flotation stream and a comminution unit for comminuting the valuable coarse flotation stream and producing a fines stream for processing in the recovery unit.

Invention 2

In broad terms, invention 2 takes a coarser stream from a conventional comminution circuit for an ore obtained from a sulphide ore system land processes the coarser stream in an ARBS circuit and produces an (i) an ARBS milled stream and (ii) an ARBS process fines stream and recovers gold and/or copper from the ARBS milled stream.

In a conventional SABC circuit (described above), pebbles (sometimes referred to as “scats”) are the coarse stream from a SAG mill. Pebbles are discharged from a SAG mill (typically around 10 mm-80 mm depending on the SAG configuration of the SABC circuit. The pebbles are then crushed in a cone-crusher or other suitable pebble crusher and added back to the SAG mill feed.

The use of the ARBS circuit replaces the pebble crusher in the SABC circuit and provides an alternative processing route for this material.

In broad terms, invention 2 provides a process for recovering valuable material in the form of gold and/or copper from a sulphide ore system that includes:
(a) comminuting an ore obtained from a sulphide ore system (which may be run-of-mine (ROM) including stockpiled ore or at least primary crushed ore) in a comminution circuit, such as a conventional comminution circuit, such as a crushing and milling circuit, and producing a fines stream and a coarser stream;
(b) comminuting the coarser stream in an Accurate Rock Breakage System (“ARBS”) circuit and producing (i) an ARBS milled stream and (ii) an ARBS process fines stream; and
(c) recovering, for example via a flotation circuit, gold and/or copper from the ARBS milled stream.

The ore may be run-of-mine (ROM) ore including stockpiled ROM ore.

The ore may be primary crushed ore.

The process may include processing ore between a mine (or a stockpile of mined ore) and step (a). For example, the ore may be processed by being sorted by grade (i.e. concentration, of valuable or non-valuable elements/compounds in the ore) and/or particle size between the mine (or the stockpile of mined ore) and step (a). For example, the grade sorting may be bulk and/or particle sorting.

The process may include processing the fines stream and/or the coarser stream before downstream steps. For example, the process may include sorting the fines stream and/or the coarser stream by grade (i.e. concentration, of valuable or non-valuable elements/compounds) before downstream processing steps such as step (b) in the case of the coarser stream. For example, the grade sorting may be bulk and/or particle sorting.

The process may include recovering, for example via a flotation circuit, gold and/or copper, from the ARBS fines stream.

The process may include processing the ARBS milled stream in a coarse particle flotation circuit, such as an Eriez coarse particle flotation circuit, and producing a valuable coarse flotation stream.

There may be multiple coarse particle flotation stages in the coarse particle flotation circuit.

The coarse particle flotation circuit may include a plurality of coarse particle flotation stages, in series or parallel.

The process may include recovering, for example via a flotation circuit, gold and/or copper, from the valuable coarse flotation stream.

The process may include comminuting the valuable coarse flotation stream and producing a fines stream.

The process may include recovering, for example via a flotation circuit, gold and/or copper, from the fines stream.

The process may include recovering, for example via a flotation circuit, gold and/or copper from the fines stream produced in step (a).

The particles in the fines stream produced in step (a) may be any suitable size range.

By way of example, in a gold/copper mining operation, the particles in the fines stream produced in step (a) may be less than 10 mm.

The particles in the coarser stream produced in step (a) may be equal to or greater than 10 mm.

It is noted that the above reference to 10 mm as the cut-off between the fines stream and the coarser stream produced in step (a) is an example only. The cut-off may be any suitable particle size having regard to ore type, operating conditions, and other factors.

The particles in the coarser stream may be less than 100 mm, typically less than 90 mm, and typically less than 80 mm.

The ARBS milled stream may be 50-1000 microns.

The ARBS milled stream may be at least 50 microns, typically at least 75 microns.

The ARBS milled stream may be less than 1000 microns, typically less than 600 microns, more typically less than 500 microns.

Typically, the ARBS milled stream distribution may have a P80 (80% of the stream mass lower than) a range from 150-600 microns, typically 150-400 microns.

The invention also provides a plant for recovering valuable material in the form of gold and/or copper from a sulphide ore system that includes:
(a) a comminution unit for comminuting an ore from a sulphide ore system (which may be run-of-mine (ROM) including stockpiled ore or at least primary crushed ore) in a comminution circuit, such as a conventional comminution circuit, such as a crushing and milling circuit, and producing a fines stream and a coarse stream;
(b) an Accurate Rock Breakage System (“ARBS”) unit for comminuting the coarser stream and producing (i) an ARBS milled stream and (ii) an ARBS process fines stream;
(c) a recovery unit for recovering, for example via flotation, gold and/or copper from the ARBS milled stream.

The plant may include recovery unit for recovering, for example via flotation, gold and/or copper from the fines stream.

The plant may include recovery unit for recovering, for example via flotation, gold and/or copper from the ARBS process fines stream.

The plant may include a coarse particle flotation circuit, such as an Eriez coarse particle flotation circuit, for the ARBS milled stream for producing a valuable coarse flotation stream and a comminution unit for comminuting the valuable coarse flotation stream and producing a fines stream for processing in the recovery unit.

Invention 3

In broad terms, invention 3 takes an ARBS milled stream produced in an ARBS circuit obtained from ore from a sulphide ore system and processes this in a coarse flotation circuit, such as an Eriez coarse particle flotation circuit, and produces a valuable coarse flotation stream and recovers gold and/or copper from the valuable coarse flotation stream.

The ARBS milled stream can be processed directly in the coarse flotation circuit.

In addition to a high average recovery, a coarse tailings stream produced in the coarse flotation circuit is more amenable to de-watering tails disposal (e.g. thickening, dry-stacking, sand for dam construction etc.) than the output of a conventional flotation circuit. It is noted that this feature of the coarse tailings stream produced in the coarse flotation circuit is also a feature of the processes of inventions 1,2 and 4.

In broad terms, invention 3 provides a process for recovering valuable material in the form of gold and/or copper from a sulphide ore system that includes:
(a) comminuting an ore obtained from a sulphide ore system (which may be run-of-mine (ROM) including stockpiled ore or at least primary crushed ore) in an Accurate Rock Breakage System (“ARBS”) circuit and producing (i) an ARBS milled stream and (ii) an ARBS fines stream;
(b) processing the ARBS milled stream in a coarse particle flotation circuit, such as an Eriez coarse particle flotation circuit, and producing a valuable coarse flotation stream; and
(c) recovering, for example via a flotation circuit, gold and/or copper from the valuable coarse flotation stream.

The ore may be run-of-mine (ROM) ore.

The ore may be primary crushed ore.

The process may include processing ore between a mine (or a stockpile of mined ore) and step (a). For example, the ore may be processed by being sorted by grade (i.e. concentration, of valuable or non-valuable elements/compounds in the ore) between the mine (or the stockpile of mined ore) and step (a). For example, the grade sorting may be bulk and/or particle sorting.

The process may include processing the ARBS milled stream before step (b). For example, the process may include sorting the ARBS milled stream by grade (i.e. concentration, of valuable or non-valuable elements/compounds). For example, the grade sorting may be bulk and/or particle sorting.

The process may include recovering, for example via a flotation circuit, gold and/or copper from the ARBS fines stream.

The process may include, before step (a), separating the ore, for example by screening, into a fines fraction and a coarser fraction and comminuting the coarser fraction in step (a).

The process may include recovering, for example via a flotation circuit, gold and/or copper from the fines fraction.

The process may include comminuting the fines fraction and producing a fines stream.

The process may include recovering, for example via a flotation circuit, gold and/or copper from the fines stream.

Step (b) may include multiple coarse particle flotation stages in the coarse particle flotation circuit.

The coarse particle flotation circuit may include a plurality of coarse particle flotation stages, in series or parallel.

The process may include comminuting the valuable coarse flotation stream from step (b) and producing a fines stream.

The process may include recovering, for example via a flotation circuit, gold and/or copper, from the fines stream.

The process may include separating, for example by screening, the ARBS milled stream from step (a) and producing an ARBS circuit fraction and a coarse fraction.

The process may include comminuting the ARBS circuit fraction in the ARBS circuit.

The process may include comminuting the coarse fraction and producing a comminuted fraction and transferring the comminuted fraction to separation step (a) for processing in that step.

The ARBS milled stream may be 50-1000 microns.

The ARBS milled stream may be at least 50 microns, typically at least 75 microns.

The ARBS milled stream may be less than 1000 microns, typically less than 600 microns, more typically less than 500 microns.

Typically, the ARBS milled stream distribution may have a P80 (80% of the stream mass lower than) a range from 150-600 microns, typically 150-400 microns.

The invention also provides a plant for recovering valuable material in the form of gold and/or copper from a sulphide ore system that includes;
(a) an Accurate Rock Breakage System (“ARBS”) unit for comminuting an ore from a sulphide ore system (which may be run-of-mine (ROM) or at least primary crushed ore) and producing (i) an ARBS milled stream and (ii) an ARBS process fines stream;
(b) a coarse particle flotation circuit, such as an Eriez coarse particle flotation circuit, for processing the ARBS milled stream and producing a valuable coarse flotation stream; and
(c) a recovery unit for recovering, for example via flotation, gold and/or copper from the valuable coarse flotation stream.

The plant may include includes a separation unit for separating the ore into a fines fraction and a coarse fraction, with the Accurate Rock Breakage System (“ARBS”) unit being configured to process the coarse fraction.

The plant may include a recovery unit for recovering, for example via flotation, gold and/or copper from the fines fraction.

The plant may include a recovery unit for recovering, for example via flotation, gold and/or copper from the ARBS process fines stream.

The plant may include a comminution unit for comminuting the valuable coarse flotation stream and producing a fines stream for processing in the recovery unit.

Invention 4

In broad terms, invention 4 takes an ARBS milled stream produced in an ARBS circuit obtained from a sulphide ore system feed material and recovers gold and/or copper from the ARBS milled stream.

In broad terms, invention 4 provides a process for recovering valuable material in the form of gold and/or copper from a sulphide ore system that includes:
(a) comminuting a sulphide ore system feed material (which may be run-of-mine (ROM) or at least primary crushed ore) in an Accurate Rock Breakage System (“ARBS”) circuit and producing (i) an ARBS milled stream and (ii) an ARBS process fines stream;
(b) recovering, for example via a flotation circuit, gold and/or copper from the ARBS milled stream.

The process may include recovering, for example via a flotation circuit, gold and/or copper from the ARBS process fines stream.

The process may include: (i) comminuting the ARBS milled stream and producing a fines stream and (ii) recovering, for example via a flotation circuit, gold and/or copper from the fines stream.

In broad terms, invention 4 provides a plant for recovering valuable material in the form of gold and/or copper from a sulphide ore system that includes;
(a) an Accurate Rock Breakage System (“ARBS”) unit for comminuting a sulphide ore system feed material (which may be run-of-mine (ROM) or at least primary crushed ore) and producing (i) an ARBS milled stream and (ii) an ARBS process fines stream; and
(b) a recovery unit for recovering, for example via flotation, gold and/or copper from the ARBS milled stream.

The plant may include a recovery unit for recovering, for example via flotation, gold and/or copper from the ARBS process fines stream.

The plant may include a coarse particle flotation circuit, such as an Eriez coarse particle flotation circuit, for the ARBS milled stream for producing a valuable coarse flotation stream and a comminution unit for comminuting the valuable coarse flotation stream and producing a fines stream for processing in the recovery unit.

General Invention

The general invention provides a process for recovering valuable metal from an ore system that includes:
(a) comminuting an ore system feed material in an Accurate Rock Breakage System (“ARBS”) circuit and producing (i) an ARBS milled stream and (ii) an ARBS process fines stream;
(b) recovering, for example via a flotation circuit, the valuable metal from the ARBS milled stream.

The general invention also provides a plant for recovering a valuable metal from an ore system that includes;
(a) an Accurate Rock Breakage System (“ARBS”) unit for comminuting an ore system feed material and producing (i) an ARBS milled stream and (ii) an ARBS process fines stream; and
(b) a recovery unit for recovering, for example via flotation, gold and/or copper from the ARBS milled stream.

The feed material may be any suitable feed material.

The feed material may be run-of-mine (ROM) or at least primary crushed ore.

The feed material may be separated for example by screening, into multiple size fractions including a size fraction that is suitable for processing in an ARBS circuit.

### BRIEF DESCRIPTION OF THE DRAWINGS

The inventions are described further below by way of example only with reference to the accompanying drawings, of which:

FIG. 1 is a flow sheet of one embodiment of a method and an apparatus of recovering gold and copper from sulphide ore systems in accordance with the inventions;

FIG. 2 is a flow sheet of another embodiment of a method and an apparatus of recovering gold and copper from sulphide ore systems in accordance with the inventions;

FIG. 3 is a flow sheet of another, but not the only other, embodiment of a method and an apparatus of recovering gold and copper from sulphide ore systems in accordance with the inventions; and

FIG. 4 is a flow sheet of another, but not the only other, embodiment of a method and an apparatus of recovering gold and copper from sulphide ore systems in accordance with the inventions.

### DESCRIPTION OF EMBODIMENTS

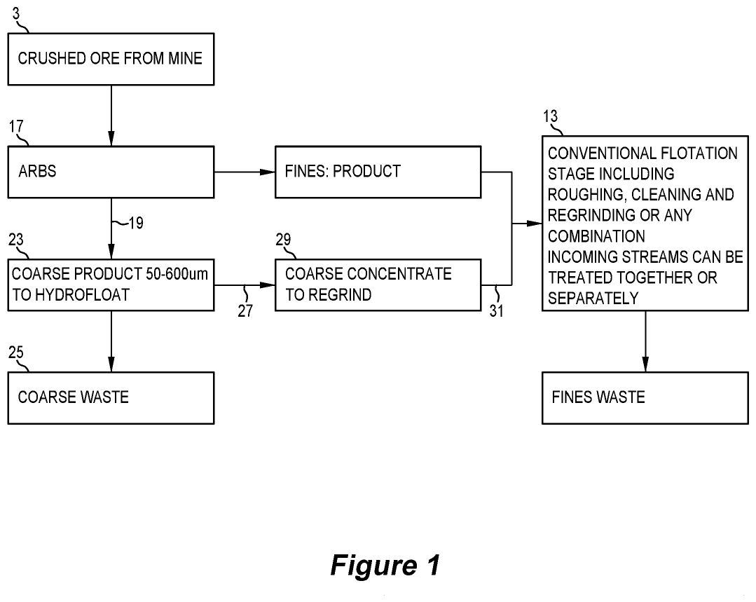

The embodiments of the method and apparatus of the inventions shown in FIGS. 1 to 3 are described in the context of recovering gold and copper from gold/copper-containing sulphide minerals in a sulphide ore system. The inventions are not confined to this application and may be used with any suitable ore systems.

FIG. 1 includes the above-described inventions 3 and 4.

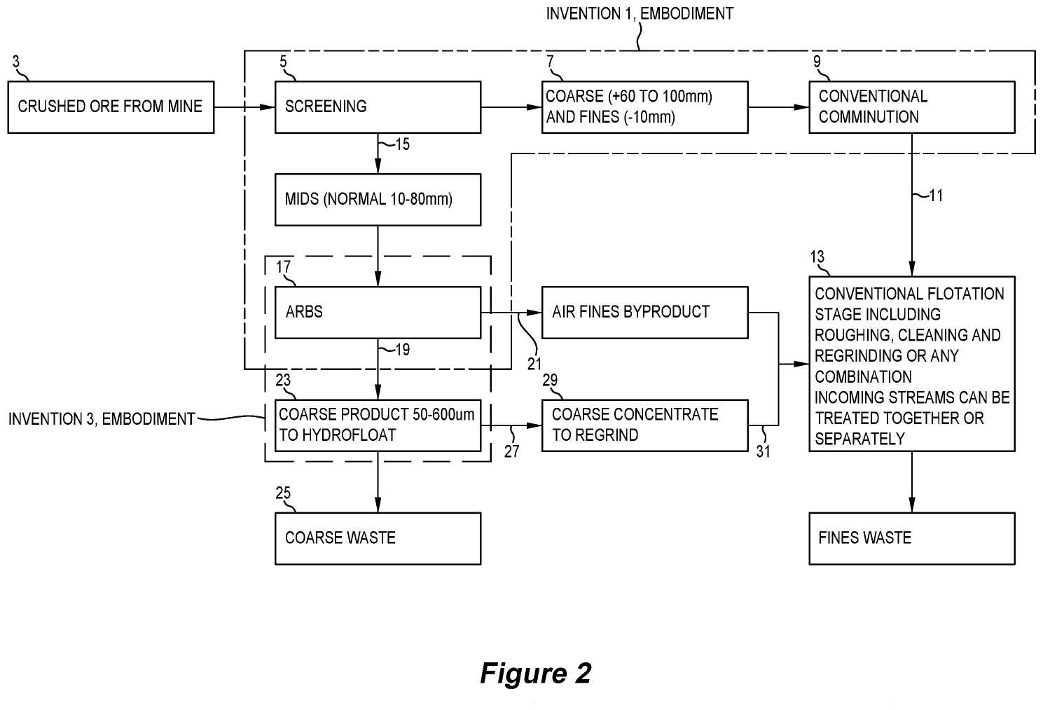

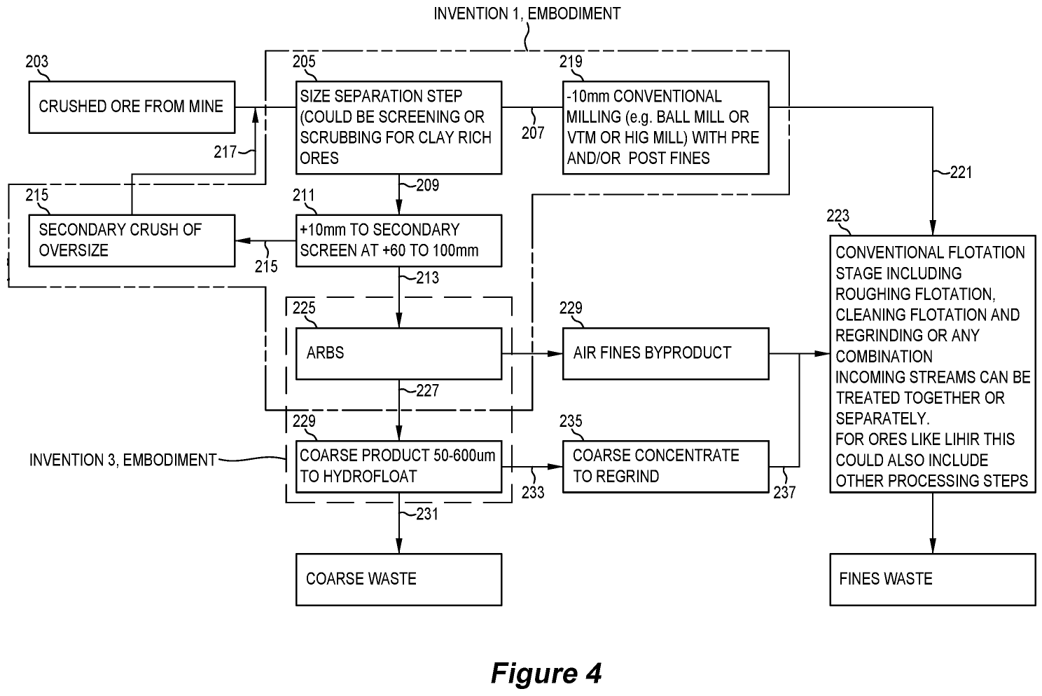

FIGS. 2 and 4 each include the above-described inventions 1 and 3.

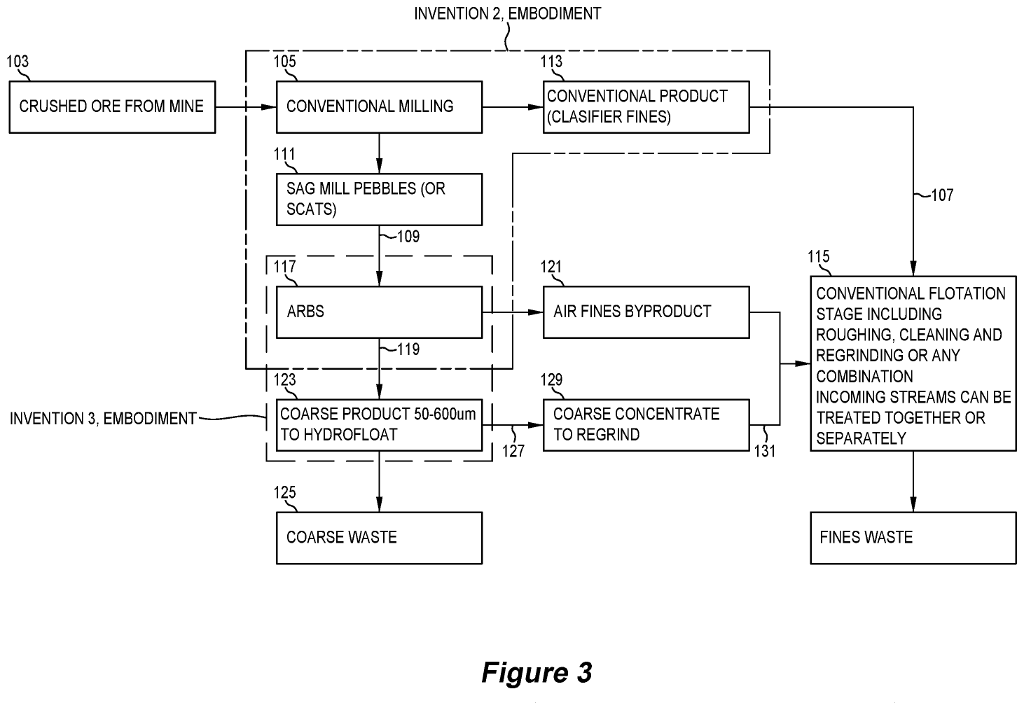

FIG. 3 includes the above-described inventions 2 and 3.

In particular, the embodiments shown in FIGS. 1 to 4 integrate an ARBS circuit, as described for example in International application PCT/IB2020/050065 (WO 2020/141496), into process flowsheets for recovering gold from gold/copper-containing sulphide minerals.

The embodiments shown in FIGS. 1-4 are suitable for brownfield and greenfield operations.

ARBS Circuit—Overview

The ARBS circuit is based on an ARBS mill comprising a vertical stack of multiple stages of horizontally-opposed pairs of rolls with each roll pair being configured to operate with single particle breakage of rock fragments passing through the roll pair so that a relatively small proportion of fragments are crushed in each roll pair.

As noted above, the ARBS circuit (process and apparatus) is described in International application PCT/IB2020/050065 (WO 2020/141496) in the name of Malcolm Strathmore Powell.

Typically, 22 to 24 such stages (or any other suitable number of stages—the test work reported below was carried out on a pilot plant having 15 stages) are provided to crush from a particle top size of 60-100 mm to a final P95 of 200 microns, (i.e. 95% of the stream mass lower than 200 microns.

Single particle breakage in each roll pair provides an opportunity to minimize energy requirements to operate the circuit.

The ARBS circuit produces a far steeper final particle size distribution curve than a conventional mill circuit, such as a SAG/ball mill circuit, and this can provide advantages in downstream process options. The inverse relationship between final grind size and machine throughput, and the exponential increase in energy, favors grinding to only the minimum size required for maximum mineral recovery.

Unlike tumbling mills, ore hardness does not impact ARBS mill throughput, but harder ores will have a higher specific crushing energy and excessively hard ores may require larger diameter rolls to ensure that the roll gaps remain within tolerances under full load.

The feed to the mill is screened to a set top size.

While there is no technical limit on the top size of the feed into the ARBS mill, practical and current economic considerations indicate an optimal top size of around 80-100 mm.

Feed stockpiling, reclaim and conveying equipment that form part of an ARBS circuit are designed to minimize segregation of a feed stream (i.e. mid-size fraction in the context of the inventions) to the ARBS mill. This requires appropriate stack and reclaim technologies (e.g. A-frame stockpile and apron feeder or a silo), minimal direction changes in the conveyor runs, and flat conveyors.

Finally, tramp metal and other contaminants need to be removed from the feed stream before entering the mill. This is performed by means of a combination of belt and roll magnets and optical detection equipment that will likely be supplied as a stand-alone tramp removal module.

Finer pre-crushing of the feed ore improves reliability of tramp removal.

The ARBS mill includes a gap release mechanism that is activated if the force between any roll pair exceeds an expected crushing force for that roll pair. This provides an additional layer of machine protection against tramp materials.

The feed stream is fed into the ARBS mill as a monolayer such that the particles are spread along the length of the first pair of rolls in a single, evenly distributed layer of material. The gaps and the roll speeds at each crushing stage are precisely controlled to exert only the minimum force required to fracture only the largest particles, but not to induce secondary breakage of the progeny, or cause the fractured particles to be compressed to the extent that they become supported by, or confined by, other particles during this breakage event. The rolls gaps can be adjusted in real time to achieve very precise and immediate control over the final ARBS milled product particle size. This stream of high-speed fine particles is decelerated within the machine and extracted from the base of the mill by means of a screw conveyor.

Each pair of crushing rolls and the drive units are housed in an independent and removable ‘roll cassette’. Each cassette incorporates all sensors, gap control and condition monitoring equipment. Cassettes are inserted and removed from an adjacent rolls hoist and the electrical components can be simply unplugged to reduce change-out times.

The modular nature of the ARBS mill stack lends itself to customization. The number of crushing stages can be varied and is determined by the total size reduction to be achieved. The mill structure can also be configured to maximize throughput given the feed ore properties and particle size distributions. Possible configurations include a single stack, one or more parallel stacks and split stacks (of which there are several variants).

The ARBS circuit is a dry system, so dust suppression is achieved via an air extraction system into a dust collector. This extraction system is sized to also extract particles that are within the final product specification from each crushing stage along the process. The dust recovery is ideally performed using a wet scrubber type system and can be kept separate from the coarser main product for separate downstream processing.

The ARBS mill is a high-precision, fast response machine that requires a fundamentally different control approach to tumbling mills.

Real-time monitoring and control of the core crushing parameters is an essential aspect of the ARBS circuit. Consequently, the ARBS mill includes an integrated control system that incorporates all sensors, data processing, user-interface, and machine control elements.

FIG. 1 Embodiment—Overview

FIG. 1 discloses embodiments of the above-described inventions 3 and 4. In broad terms,
(a) invention 4 takes an ARBS milled stream produced in an ARBS circuit and recovers gold and/or copper from the ARBS milled stream; and
(b) invention 3 includes an additional intermediate step of processing the ARBS milled stream in a coarse flotation circuit and producing a valuable coarse flotation stream, and then recovering gold and/or copper from the valuable coarse flotation stream.

FIG. 1 Embodiment—More Detailed Description

With reference to FIG. 1, primary crushed ore 3 from a mine (which may include a stockpile at the mine) is transferred to an ARBS circuit 17 and processed in the circuit and produces the following products, noting that the invention is not confined to the particle size ranges set out below:
(a) a “coarse product of 50-600 microns” (as described in FIG. 1), which is an ARBS milled stream 19; and
(b) a “fines product” (as described in FIG. 1), which is an ARBS fines stream 21.

The ARBS fines stream 21 is transferred to a conventional fines flotation circuit 13 and processed to produce a valuable concentrate.

The ARBS milled stream 19 is transferred to an Eriez Hydrofloat™ coarse particle flotation circuit 23 or any other suitable coarse particle flotation circuit. The coarse flotation circuit 23 produces (a) a coarse waste stream 25 and (b) a coarse concentrate stream 27 containing gold and copper.

It is noted that the coarse particle flotation circuit 23 may include a plurality of stages, in series or parallel.

The coarse concentrate stream 27 is transferred to a comminution circuit 29 that produces a fines stream 31. The fines stream 31 is transferred to the conventional fines flotation circuit 13 and processed to produce a valuable concentrate.

The embodiment described above in relation to the diagrammatic flowsheet of FIG. 1 is now described in more detail in the context of examples of equipment for the embodiment.

Conventional Flotation Circuit 13

The flotation circuit 13 is a conventional flotation circuit which, in this embodiment, includes StackCell™ flotation cells ahead of rougher flotation cells, and produces a concentrate that contains gold and copper.

ARBS Circuit 17—Feed Preparation

The ARBS circuit 17 typically needs a reliable system of metallic and non-metallic tramp removal down to a size smaller than the finest rolls gap in the mill.

The mid-size fraction in the ARBS storage silo is reclaimed via a belt feeder, and then conveyed to a magnetic roll assembly facility having a drum magnet. From the silo to the drum magnet, there are two overhead hanging self-cleaning belt magnets at transfer points to remove metallic tramp from a bed on the conveyor. The first magnet is installed at the discharge of the belt feeder and the second magnet is installed at the discharge of the drum magnet feed conveyor.

The drum magnets remove smaller magnetic material, which will preferentially be on the bottom of the bed and thus pass closest to the drum. Additionally, the drum has a ceramic magnet that removes only slightly magnetic material, such as tungsten carbide wear components.

At the discharge end of the drum magnet, an image-based sorting device will be installed for rejecting the non-metallics. The drum magnet discharges materials onto the main ARBS circuit feed conveyor, which has a metal detector mounted ahead of a diverter plow. If the image sorting device and/or the metal detector triggers, the feed will be briefly diverted to a reject pile via the diverter plow and conveyor that exits the building.

A metal detector inter-locked with the ARBS circuit 17 is also installed between the magnetic removal systems and the circuit 17 as a further protection system.

ARBS Circuit 17

All conveyors up to the main ARBS feed conveyor are flat-profile conveyor belts selected to ensure even and non-segregated distribution across the belt.

In this embodiment, the ARBS circuit feed conveyor is a high-angle sandwich conveyor that is configured to minimize the distance between the magnetic roll assembly and the ARBS mill.

To ensure efficient comminution performance of the ARBS mill, a feed spreader is used ahead of the ARBS circuit 17 to spread the feed into a thin layer across the full belt surface before feeding as a mono-layer into the ARBS mill itself. An apron feeder with an auger spreader or any other suitable device is used to ensure the ARBS circuit feed requirements are met.

As noted above, the ARBS circuit 17 is a dry system, therefore a wet scrubber system is installed for dust suppression and fines extraction. This extraction system extracts particles that are within the final product specification from each crushing stage along the process. The dust collection discharge is separate from the ARBS circuit product.

The fines are pumped to the rougher flotation stage of the conventional flotation circuit 13 which in this embodiment includes StackCell™ flotation cells ahead of rougher flotation cells.

Coarse Flotation Circuit 23

The ARBS circuit product is discharged via a screw conveyor to a compact mixing tank-pumping system below the ARBS circuit 17.

The slurry is pumped directly to a downstream Hydrofloat™ coarse particle flotation circuit that includes a coarse particle flotation cell or to any other suitable coarse particle flotation circuit.

A conditioning tank is installed ahead of the Hydrofloat™ coarse particle flotation cell to receive the ARBS mill coarse product. This allows for rolls change-out on the ARBS mill while keeping a more stable flow to the Hydrofloat™ coarse particle flotation cell.

The conditioning tank is also used as the reagent conditioning tank ahead of the Hydrofloat™ coarse particle flotation cell.

FIG. 2 Embodiment—Overview

The same reference numerals in FIGS. 1 and 2 describe the same features.

There are two key features of the FIG. 2 flow sheet, namely:
(a) screening crushed ROM ore (which, for example has been primary crushed) and splitting the crushed ROM ore into fines (minus 10 mm), mid-size (nominally 10-80 mm), and coarse (60-100 mm) fractions and processing the mid-size fraction in an ARBS circuit and processing the fines and coarse fractions in a conventional comminution circuit, such as a crushing and milling circuit, such as a SAG/ball mill circuit, such as a SABC (SAG Ball Crush) circuit; and
(b) transferring a milled ARBS product (as opposed to a fines product) from the ARBS circuit to a coarse flotation circuit, such as an Eriez Hydrofloat™ coarse particle flotation unit, and producing a valuable coarse concentrate.

There are several reasons for screening crushed ROM feed material and splitting the feed to the ARBS circuit and the SAG/ball mill circuit, including:
Improved efficiency of the SAG/ball mill circuit by removal of critical size material which has inherently lower breakage rates in the SAG mill.
Removal of fines ahead of the ARBS mill simplifies the configuration of the ARBS mill and reduces the quantum of air-classification requirement within the mill.
Removal of fines from the ARBS circuit enhances the application of a coarse flotation circuit and creates fines devoid tails for easier disposal.
The ARBS circuit produces a steep particle size distribution curve, with a final gap limited to approximately 250 microns. This discharge is an ideal size distribution for feed to coarse flotation circuit, without any additional classification requirements. Therefore, pairing an ARBS circuit and a coarse flotation circuit produces a favourable recovery scenario, while also minimising the size reduction applied to the feed ore.

It is noted that in this and other embodiments of the invention, the milled ARBS product is transferred to a comminution circuit to reduce the particle size of the ARBS milled product to that suitable for conventional fines flotation. In these embodiments, the comminution circuit replaces the coarse flotation circuit.

FIG. 2 discloses embodiments of the above-described inventions 1 and 3.

The invention 1 embodiment is described by the border marked “invention 1 embodiment”.

The invention 3 embodiment is described by the border marked “invention 3 embodiment”.

FIG. 2 Embodiment—More Detailed Description

With reference to FIG. 2, primary crushed ore 3 from a mine (which may include a stockpile at the mine) is transferred to a screening circuit 5 and separated into a fines fraction, a mid-size fraction, and a coarse fraction.

The particle size ranges of the fractions are dependent on a range of factors relevant to a mine, including mineralogy of the ore and operating parameters of plant equipment. The skilled person will be able to determine optimum particular size ranges for the fractions in any given mine, noting that there are no absolutes in the selections and the selections are based on balancing sometimes competing interests.

The following optimum particular size ranges apply to the embodiment shown in FIG. 2, noting that the invention is not limited to these size ranges:
fines fraction—minus 10 mm
mid-size fraction—nominal 10-80 mm
coarse fraction 60-100 mm

It is also noted that the primary crushed ore 3 that is transferred to the screening circuit 5 may not be the whole of the mine production. For example, part of the mine production may be processed in other process flowsheets. In addition, the mine production ear-marked for transfer to the screening circuit 5 may be processed in bulk and/or particle sorting operations to confine the volume of material transferred to the screening circuit 5 to “higher” grade material.

The fines and coarse fractions 7 are transferred to a conventional comminution circuit 9. Typically, the circuit includes a SAG/ball mill comminution circuit, with the circuit producing a fines stream (i.e. slurry) 11 as overflow from circuit cyclones.

It is noted that the embodiment (and the inventions) is not confined to a SAG/ball mill comminution circuit and, in addition, extends to any suitable commination circuit for processing fines and coarse fractions and producing a fines stream that may be developed in the future. In other words, the construction and operation of the comminution circuit is not an essential aspect of the embodiment (and the inventions).

The fines stream 11 from the comminution circuit 9 is transferred to a conventional fines flotation circuit 13, including suitable rougher, cleaning, and regrinding stages, that can process any suitable combinations of fines streams from the plant.

The fines flotation circuit 13 produces a concentrate that contains gold and copper.

It is noted that the embodiment (and the inventions) extends to any suitable fines flotation circuit that may be developed in the future. In other words, the construction and operation of the fines flotation circuit is not an essential aspect of the embodiment (and the inventions).

The mid-size fraction 15 from the screening circuit 5 is transferred to an ARBS circuit 17 and processed in the circuit and produces the following products, noting that the invention is not confined to the particle size ranges set out below:
(a) a “coarse product of 50-600 microns” (as described in FIG. 2), which is an ARBS milled stream 19; and
(b) an “air fines byproduct” (as described in FIG. 2), which is an ARBS fines stream 21.

The ARBS fines stream 21 is transferred to the conventional fines flotation circuit 13 and processed to produce a valuable concentrate.

The ARBS milled stream 19 is transferred to an Eriez Hydrofloat™ coarse particle flotation circuit 23 or any other suitable coarse particle flotation circuit. The coarse flotation circuit 23 produces (a) a coarse waste stream 25 and (b) a coarse concentrate stream 27 containing gold and copper.

It is noted that the coarse particle flotation circuit 23 may include a plurality of stages, with oversized material form one stage being returned to that stage.

The coarse concentrate stream 27 is transferred to a comminution circuit 29 that produces a fines stream 31. The fines stream 31 is transferred to the conventional fines flotation circuit 13 and processed to produce a valuable concentrate.

The embodiment described above in relation to the diagrammatic flowsheet of FIG. 1 is now described in more detail in the context of examples of equipment for the embodiment.

Screening Circuit 5

The screening circuit 5 separates the mid-size fraction from the primary crusher product that is transferred to the circuit 5. As described above, the mid-size fraction is processed in the ARBS mill 17.

The screening circuit 5 includes a vibrating screen, which can be a grizzly or mesh screen (or any other suitable option), in line with an overland conveyor to pull oversize material off the belt and redirect it to a coarse ore stockpile.

Screen undersize is conveyed to a secondary screening plant for subsequent extraction of the mid-size fraction. This assembly resolves capacity and oversize issues in one step by integrating the vibrating screen with the overflowing bypass, which allows for partial or full bypass if the double deck screens on the ARBS feed stream are overloaded.

A double deck vibrating screen extracts the mid-size fraction (−100+25 mm) from the screen undersize in the secondary screening plant.

The screen oversize is sent to an ARBS feed storage facility, and the screen undersize is transferred to an overland conveyor prior to feeding the main coarse ore stockpile ahead of the SAG mill in the conventional comminution circuit 9.

The screen undersize (top size of 10-25 mm) from the double deck vibrating screen is pumped directly to a SAG mill discharge screen. This option could significantly reduce the overall dust generation at the coarse ore stockpile, without sacrificing ball mill grinding efficiency.

Another option is to pump the screen undersize to the SAG mill feed inlet.

It is noted that it is also possible to operate with one screening plant rather than two screening plants, with just a single double-deck screen, say 80-100 mm top deck, 10 mm bottom deck.

An alternative is a coarse scalping screen directly feeding a double-deck screen in the same screening plant.

Coarse Ore Storage and Reclaim

Following the secondary screening process, the mid-size fraction product (−100+10−25 mm) is conveyed to a silo ahead of the ARBS circuit 17 and feed installation. The silo may be any suitable size. The silo includes a reclaim belt feeder sized to feed the mid-size fraction to the ARBS circuit 17.

Conventional Flotation Circuit 13

As described above in relation to the FIG. 1 embodiment.

ARBS Circuit 17—Feed Preparation

As described above in relation to the FIG. 1 embodiment.

ARBS Circuit 17

As described above in relation to the FIG. 1 embodiment.

Coarse Flotation Circuit 23

As described above in relation to the FIG. 1 embodiment.

Conventional Comminution Circuit 9

As noted above, the feed to the SAG/ball mill comminution circuit 9 has a bi-modal size distribution, namely fine and coarse fractions, as a result of the screening circuit 5. The cyclone overflow of the comminution circuit 9 is pumped to the rougher flotation stage.

FIG. 3 Embodiment—Overview

There are three key features of the FIG. 3 flow sheet, namely:
(a) comminuting ore (which, for example has been primary crushed) in a comminution circuit, such as a conventional comminution circuit, such as a crushing and milling circuit, and producing a 1s t process fines stream and a coarse stream;
(b) comminuting the coarse stream in an Accurate Rock Breakage System (“ARBS”) circuit and producing (i) an ARBS milled stream and (ii) an ARBS process fines stream transferring a milled ARBS product (as opposed to a fines product) from the ARBS circuit to a coarse flotation circuit, such as an Eriez Hydrofloat™ coarse particle flotation unit, and producing a valuable coarse concentrate.
(c) and recovering, for example via a flotation circuit, gold and/or copper from at least the 1^{st} process fines stream and the ARBS milled stream.

FIG. 3 discloses embodiments of the above-described inventions 2 and 3.

The invention 2 embodiment is described by the border marked “invention 2 embodiment”.

The invention 3 embodiment is described by the border marked “invention 3 embodiment”.

FIG. 3 Embodiment—More Detailed Description

With reference to FIG. 3, primary crushed ore 103 from a mine is transferred to a comminution circuit, such as a SAG/ball mill comminution circuit in the form of a SAG mill 105, a pebble crusher 111, and a ball mill 113, that produces a 1s t process fines stream 107 and a coarse stream 109.

The particle size ranges of the fines and the coarse streams are dependent on a range of factors relevant to a mine, including mineralogy of the ore and operating parameters of plant equipment. The skilled person will be able to determine optimum particular size ranges for the streams in any given mine, noting that there are no absolutes in the selections and the selections are based on balancing sometimes competing interests.

The following optimum particular size ranges apply to the embodiment shown in FIG. 3, noting that the invention is not limited to these size ranges:
fines stream—minus 10 mm
coarse stream—nominal 10-80 mm

It is also noted that the primary crushed ore 103 that is transferred to the comminution circuit may not be the whole of the mine production. For example, part of the mine production may be processed in other process flowsheets. In addition, the mine production ear-marked for transfer to the comminution circuit may be processed in bulk and/or particle sorting operations to confine the volume of material transferred to the comminution circuit to “higher” grade material.

It is noted that the embodiment (and the inventions) is not confined to a SAG/ball mill comminution circuit and, in addition, extends to any suitable commination circuit for processing fines and coarse fractions and producing a fines stream that may be developed in the future. In other words, the construction and operation of the comminution circuit is not an essential aspect of the embodiment (and the inventions).

The fines stream 107 from the comminution circuit 105, 111, 113 is transferred to a conventional fines flotation circuit 115, including suitable rougher, cleaning, and regrinding stages, that can process any suitable combinations of fines streams from the plant.

The fines flotation circuit 115 produces a concentrate that contains gold and copper.

It is noted that the embodiment (and the inventions) extends to any suitable fines flotation circuit that may be developed in the future. In other words, the construction and operation of the fines flotation circuit is not an essential aspect of the embodiment (and the inventions).

The coarse stream 109 from the comminution circuit 105, 111, 113 is transferred to an ARBS circuit 117 and processed in the circuit and produces the following products, noting that the invention is not confined to the particle size ranges set out below:
(a) a “coarse product of 50-600 microns” (as described in FIG. 1), which is an ARBS milled stream 119; and
(b) an “air fines byproduct” (as described in FIG. 1), which is an ARBS fines stream 121.

The ARBS fines stream 121 is transferred to the conventional fines flotation circuit 115 and processed to produce a valuable concentrate.

The ARBS milled stream 119 is transferred to a Hydrofloat™ coarse particle flotation circuit 123 or any other suitable coarse particle flotation circuit. The coarse flotation circuit produces (a) a coarse waste stream 125 and (b) a coarse concentrate stream 127 containing gold and copper.

It is noted that the coarse particle flotation circuit 123 may include a plurality of stages, with oversized material form one stage being returned to that stage.

The coarse concentrate stream 127 is transferred to a comminution circuit 129 that produces a fines stream 131. The fines stream 131 is transferred to the conventional fines flotation circuit 115 and processed to produce a valuable concentrate.

FIG. 4 Embodiment—Overview

As is the case with the FIG. 2 embodiment, there are two key features of the FIG. 4 flow sheet, namely:
(a) screening crushed ROM ore (which, for example has been primary crushed) and splitting the crushed ROM ore into fines, mid-size (typically 20-100 mm), and coarse fractions and processing the mid-size fraction in an ARBS circuit and processing the fines and the coarse fractions in a conventional comminution circuit, such as a crushing and milling circuit, such as a SAG/ball mill circuit, such as a SABC (SAG Ball Crush) circuit; and
(b) transferring a milled ARBS product (as opposed to a fines product) from the ARBS circuit to a coarse flotation circuit, such as an Eriez Hydrofloat™ coarse particle flotation unit, and producing a valuable coarse concentrate.

FIG. 4 discloses embodiments of the above-described inventions 1 and 3.

The invention 1 embodiment is described by the border marked “invention 1 embodiment”.

The invention 3 embodiment is described by the border marked “invention 3 embodiment”.

FIG. 4 Embodiment—More Detailed Description

It is noted initially that the primary crushed ore 203 from a mine may not be the whole of the mine production. For example, part of the mine production may be processed in other process flowsheets. In addition, the crushed ore 203 may be processed in bulk and/or particle sorting operations to confine the volume of material processed in this embodiment to “higher” grade material.

With reference to FIG. 4, primary crushed ore 203 from a mine is transferred to a size separation circuit 205 (such as screens) and separated into a fines fraction 207 and a coarse fraction 209.

The coarse fraction 209 is transferred to a second size separation circuit 211 (such as screens) and separated into a mid-size fraction 213 and a coarse fraction 215.

The particle size ranges of the fractions are dependent on a range of factors relevant to a mine, including mineralogy of the ore and operating parameters of plant equipment. The skilled person will be able to determine optimum particular size ranges for the fractions in any given mine, noting that there are no absolutes in the selections and the selections are based on balancing sometimes competing interests.

The following optimum particular size ranges apply to the embodiment shown in FIG. 4, noting that the invention is not limited to these size ranges:
fines fraction—minus 10 mm
mid-size fraction—nominal 10-80 mm
coarse fraction 60-100 mm

The coarse fraction 215 is transferred to a secondary crusher 217 and crushed and forms a crushed fraction 217. The crushed fraction 217 is transferred to the size separation circuit 205.

The fines fraction 207 from the size separation circuit 205 is transferred to a conventional comminution circuit 219, for example in the form of a ball mill or vertical tower mill or a high intensity grinding mill, producing a fines stream (i.e. slurry) 221.

It is noted that the embodiment (and the inventions) is not confined to comminution circuit 219 and, in addition, extends to any suitable comminution circuit for processing fine fractions and producing a fines stream that may be developed in the future. In other words, the construction and operation of the comminution circuit is not an essential aspect of the embodiment (and the inventions).

The fines stream 221 from the comminution circuit 219 is transferred to a conventional fines flotation circuit 223, including suitable rougher, cleaning, and regrinding stages, that can process any suitable combinations of fines streams from the plant.

The fines flotation circuit 223 produces a concentrate that contains gold and copper.

It is noted that the embodiment (and the inventions) extends to any suitable fines flotation circuit 223 that may be developed in the future. In other words, the construction and operation of the fines flotation circuit is not an essential aspect of the embodiment (and the inventions).

The mid-size fraction 213 from the second size separation circuit 211 is transferred to an ARBS circuit 225 and processed in the circuit and produces the following products, noting that the invention is not confined to the particle size ranges set out below:
(a) a “coarse product of 50-600 microns” (as described in FIG. 1), which is an ARBS milled stream 227; and
(b) an “air fines byproduct” (as described in FIG. 1), which is an ARBS fines stream 229.

The ARBS fines stream 229 is transferred to the conventional fines flotation circuit 223 and processed to produce a valuable concentrate.

The ARBS milled stream 227 is transferred to an Eriez Hydrofloat™ coarse particle flotation circuit 229 or any other suitable coarse flotation circuit. The coarse flotation circuit 229 produces (a) a coarse waste stream 231 and (b) a coarse concentrate stream 233 containing gold and copper.

It is noted that the coarse particle flotation circuit 229 may include a plurality of stages, with oversized material form one stage being returned to that stage.

The coarse concentrate stream 233 is transferred to a comminution circuit 235 that produces a fines stream 237. The fines stream 237 is transferred to the conventional fines flotation circuit 223 and processed to produce a valuable concentrate.

Test Work

The applicant, CRI and an independent engineering services company completed process modelling of the process shown in the invention 1 embodiment using JKSimMet software (industry standard simulation software for minerals processing applications provided by JKTech Pty Ltd). The model was used to generate a mass balance and associated process design criteria to allow the independent engineering company to complete a concept design of the process, including the estimation of capital and operating costs relative to a conventional circuit.

The applicant has also carried out metallurgical testwork on ore samples obtained from their own mines. The samples were processed in a 15 stage ARBS pilot plant to produce an ARBS product at different target sizes and fines. The ARBS products were subsequently treated in a laboratory scale coarse particle flotation machine, Eriez Hydrofloat™; the coarse concentrate thereby obtained was also subjected to regrinding and cleaner flotation. The fine product was tested in a conventional batch flotation cell (Denver type). The resulting metallurgical response confirmed the amenability of the applicant's ores to the process described in this application.

Many modifications may be made to the embodiments of the invention described above in relation to FIGS. 1-4 without departing from the spirit and scope of the invention.

By way of example, whilst the embodiments described in relation to FIG. 1 includes transferring the coarse concentrate stream 27 to a comminution circuit 29 and producing a fines stream 31, and the fines stream 31 is transferred to the conventional fines flotation circuit 13 and processed to produce a valuable concentrate, the invention is not limited to these steps and alternate processing options may be used for the coarse concentrate stream 27. Similar comments apply to the same steps in the embodiments described in relation to FIGS. 2, 3 and 4.

By way of example, whilst the embodiments are described in relation to FIGS. 1-4 in the context of gold and copper from sulphide ore systems, the invention is not so limited and extends to recovering any valuable metals from ores. The ores may be sulphide ore systems and oxide ore systems. The metals include any one or more of nickel, copper, lead, zinc, and silver.

By way of example, whilst the embodiments are described in relation to FIGS. 1-4 in the context of primary crushed ore being supplied as a feed material to each of the circuits, it is noted that the invention extends to any suitable feed ore.

By way of example, the invention extends to embodiments in which the feed material is the result of any suitable primary and optionally secondary crushing of ROM ore.

By way of example, the embodiments include supplying a part only of the ROM ore in a crushed form as a feed material to each of the circuits.

The feed material may be ore that has been processed, for example by being sorted by grade (i.e. concentration, of valuable or non-valuable elements/compounds in the ore) and/or particle size.

In this connection, the feed material may be the result of bulk and/or particle sorting of (a) ROM or (b) primary and optionally secondary crushed ROM.

The bulk and/or particle sorting may be on any suitable basis, including grade of a valuable metal.

By way of example, the embodiments of the invention include embodiments that include additional steps in the flow sheets shown in FIGS. 1-4. These additional steps may include bulk and/or particle sorting of process streams. By way of example, these additional steps may include size separation, such as screening, steps in addition to the particular steps shown in FIGS. 1-4.

By way of example, whilst the embodiments described in relation to FIGS. 1-4 mention flotation as the option for recovering gold and/or copper, the invention also extend to other recovery options, such as heap leaching.

1-33. (canceled)

34. A plant for recovering valuable material in the form of gold and/or copper from a sulfide ore system, the plant comprising:
(a) a separation unit for separating an ore obtained from a sulfide ore system into a fines fraction, a mid-size fraction, and a coarse fraction;
(b) an Accurate Rock Breakage System (ARBS) unit for comminuting the mid-size fraction and optionally the coarse fraction and producing (i) an ARBS milled stream and (ii) an ARBS process fines stream, the ARES circuit comprising a vertical stack of multiple stages of horizontally-opposed pairs of rolls with each roll pair of each crushing stage being configured to operate with single particle breakage of rock fragments passing through the roll pair; and
(c) a recovery unit for recovering gold and/or copper from the ARBS milled stream.

35. The plant of claim 34, further comprising a comminution unit for comminuting the fines fraction in a comminution circuit and producing a fines stream.

36. The plant of claim 35, further comprising a recovery unit for recovering gold and/or copper from the fines stream.

37. A process for recovering valuable material in the form of gold and/or copper from a sulfide ore system using the plant according to claim 34, the process comprising:
(a) separating an ore obtained from a sulfide ore system into a fines fraction, a mid-size fraction, and a coarse fraction;
(b) comminuting the mid-size and optionally the coarse fractions in an Accurate Rock Breakage System (ARBS) circuit and producing (i) an ARES milled stream and (ii) an ARBS process fines stream, the ARBS circuit comprising a vertical stack of multiple stages of horizontally-opposed pairs of rolls with each roll pair of each crushing stage being configured to operate with single particle breakage of rock fragments passing through the roll pair; and
(c) recovering gold and/or copper from the ARBS milled stream.

38. The process of claim 37, wherein the ore includes run-of-mine ore or a primary crushed ore.

39. The process of claim 37, further comprising recovering gold and/or copper from the ARBS process fines stream.

40. The process of claim 37, further comprising processing the ARES milled stream in a coarse particle flotation circuit and producing a valuable coarse flotation stream.

41. The process of claim 37, further comprising recovering gold and/or copper from the valuable coarse flotation stream.

42. A plant for recovering valuable material in the form of gold and/or copper from a sulfide ore system, the plant comprising:
(a) a comminution unit for comminuting an ore obtained from a sulfide ore system in a comminution circuit and producing a fines stream and a coarser stream;
(b) an Accurate Rock Breakage System (ARBS) unit for comminuting the coarser stream and producing (i) an ARES milled stream and (ii) an ARES process fines stream, the ARBS circuit comprising a vertical stack of multiple stages of horizontally-opposed pairs of rolls with each roll pair of each crushing stage being configured to operate with single particle breakage of rock fragments passing through the roll pair; and
(c) a recovery unit for recovering gold and/or copper from the ARBS milled stream.

43. The plant of claim 42, wherein the ARBS circuit includes an air extraction system for extracting dust and particles that are within the final product specification from each crushing stage and forming the ARBS process fines stream.

44. The plant of claim 42, comprising a coarse particle flotation circuit for processing the ARBS milled stream and producing a valuable coarse flotation stream.

45. The plant of claim 44, comprising comminution unit for comminuting the valuable coarse flotation stream and producing a fines stream.

46. The plant of claim 45, comprising a recovery unit for recovering gold and/or copper from the fines stream.

47. The plant of claim 42, comprising a recovery unit for recovering gold and/or copper from the ARBS process fines stream.

48. The plant of claim 42, further comprising a recovery unit for recovering gold and/or copper from the fines stream.

49. A process for recovering valuable material in the form of gold and/or copper from a sulfide ore system using the plant according to claim 42, the process comprising:
(a) comminuting an ore obtained from a sulfide ore system in a comminution circuit and producing a fines stream and a coarser stream than the fines stream;
(b) comminuting the coarser stream in an Accurate Rock Breakage System (ARBS) circuit and producing (i) an ARES milled stream and (ii) an ARES fines stream, the ARBS circuit comprising a vertical stack of multiple stages of horizontally-opposed pairs of rolls with each roll pair of each crushing stage being configured to operate with single particle breakage of rock fragments passing through the roll pair; and
(c) recovering gold and/or copper from the ARBS milled stream.

50. The process of claim 49, further comprising processing the ARBS milled stream in a coarse particle flotation circuit and producing a valuable coarse flotation stream.

51. The process of claim 50, further comprising comminuting the valuable coarse flotation stream and producing a fines stream.

52. The process of claim 51, further comprising recovering gold and/or copper from the fines stream.
